(19) United States
(12) Patent Application Publication
(10) Pub. No.: US 2024/0098232 A1
(43) Pub. Date: Mar. 21, 2024

(54) Partial Perspective Correction with Mitigation of Vertical Disparity

(71) Applicant: Apple Inc., Cupertino, CA (US)

(72) Inventors: Emmanuel Piuze-Phaneuf, Los Gatos, CA (US); Hermannus J. Damveld, Santa Clara, CA (US); Jean-Nicola F. Blanchet, Montreal (CA); Mohamed Selim Ben Himane, Palo Alto, CA (US); Vincent Chapdelaine-Couture, Carignan (CA); Xiaojin Shi, Cupertino, CA (US)

(21) Appl. No.: 18/369,621

(22) Filed: Sep. 18, 2023

Related U.S. Application Data
(60) Provisional application No. 63/407,805, filed on Sep. 19, 2022.
(60) Provisional application No. 63/470,697, filed on Jun. 2, 2023.

(51) Int. Cl. H04N 13/117; H04N 13/383

(52) U.S. Cl. CPC H04N 13/117; H04N 13/383

(57) ABSTRACT

In one implementation, a method of performing perspective correction is performed by a device having a three-dimensional device coordinate system and including a first image sensor, a first display, one or more processors, and non-transitory memory. The method includes capturing, using the first image sensor, a first image of a physical environment. The method includes transforming the first image from a first perspective of the first image sensor to a second perspective based on a difference between the first perspective and the second perspective, wherein the second perspective is a first distance away from a location corresponding to a first eye of a user less than a second distance between the first perspective and the location corresponding to the first eye of the user. The method includes displaying, on the first display, the transformed first image of the physical environment.

### CROSS-REFERENCE TO RELATED APPLICATIONS

This application claims priority to U.S. Provisional Patent App. No. 63/407,805, filed on Sep. 19, 2022, and U.S. Provisional Patent App. No. 63/470,697, filed on Jun. 2, 2023, which are both incorporated by reference in their entireties.

### TECHNICAL FIELD

The present disclosure generally relates to systems, methods, and devices for performing partial perspective correction.

### BACKGROUND

In various implementations, an extended reality (XR) environment is presented by a head-mounted device (HMD). Various HMDs include a scene camera that captures an image of the physical environment in which the user is present (e.g., a scene) and a display that displays the image to the user. In some instances, this image or portions thereof can be combined with one or more virtual objects to present the user with an XR experience. In other instances, the HMD can operate in a pass-through mode in which the image or portions thereof are presented to the user without the addition of virtual objects. Ideally, the image of the physical environment presented to the user is substantially similar to what the user would see if the HMD were not present. However, due to the different positions of the eyes, the display, and the camera in space, this may not occur, resulting in motion sickness discomfort, impaired distance perception, disorientation, and poor hand-eye coordination.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 illustrates an example scenario related to capturing an image of physical environment and displaying the captured image in accordance with some implementations.

FIG. 3 is an overhead perspective view of a physical environment.

FIG. 4A illustrates a view of the physical environment of FIG. 3 as would be seen by a left eye of a user if the user were not wearing an HMD.

FIG. 4B illustrates an image of the physical environment of FIG. 3 captured by a left image sensor of the HMD.

FIGS. 4C and 4D illustrate transformed versions of the image of FIG. 4B.

FIGS. 5-7 illustrate front views of the HMD with various perspective transforms.

FIG. 8 is a flowchart representation of a method of performing perspective correction in accordance with some implementations.

FIG. 9 is a block diagram of an example controller in accordance with some implementations.

FIG. 10 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and method for performing perspective correction. In various implementations, the method is performed by a device having a three-dimensional device coordinate system and including a first image sensor, a first display, one or more processors, and non-transitory memory. The method includes capturing, using the first image sensor, a first image of a physical environment. The method includes transforming the first image from a first perspective of the first image sensor to a second perspective based on a difference between the first perspective and the second perspective, wherein the second perspective is a first distance away from a location corresponding to a first eye of a user less than a second distance between the first perspective and the location corresponding to the first eye of the user. The method includes displaying, on the first display, the transformed first image of the physical environment.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As described above, in an HMD with a display and a scene camera, the image of the physical environment presented to the user on the display may not always reflect what the user would see if the HMD were not present due to the different positions of the eyes, the display, and the camera in space. In various circumstances, this results in motion sickness discomfort, poor distance perception, disorientation of the user, and poor hand-eye coordination, e.g., while interacting with the physical environment. Thus, in various implementations, images from the scene camera are transformed such that they appear to have been captured at the location of the user's eyes using a depth map. In various implementations, the depth map represents, for each pixel of the image, the distance from an origin to the object represented by the pixel, e.g., from a location of the image sensor, another location of the HMD, or any other location in the physical environment.

In various circumstances, transforming the images such that they appear to have been captured at the location of the user's eye introduces artifacts into the images, such as holes, warping, flickering, etc. Accordingly, in various implementations, rather than transforming the images such that they appear to have been captured at the location of the user's eyes, the images are partially transformed such that they appear to have been captured at a location closer to the location of the user's eyes than the location of the scene camera in one or more dimensions in a three-dimensional device coordinate system of the device. In various circumstances, a partial transformation introduces fewer artifacts. Further, in various circumstances, a partial transformation may also be more computationally efficient. Thus, the device is able to strike a chosen balance between user comfort, aesthetics, and power consumption.

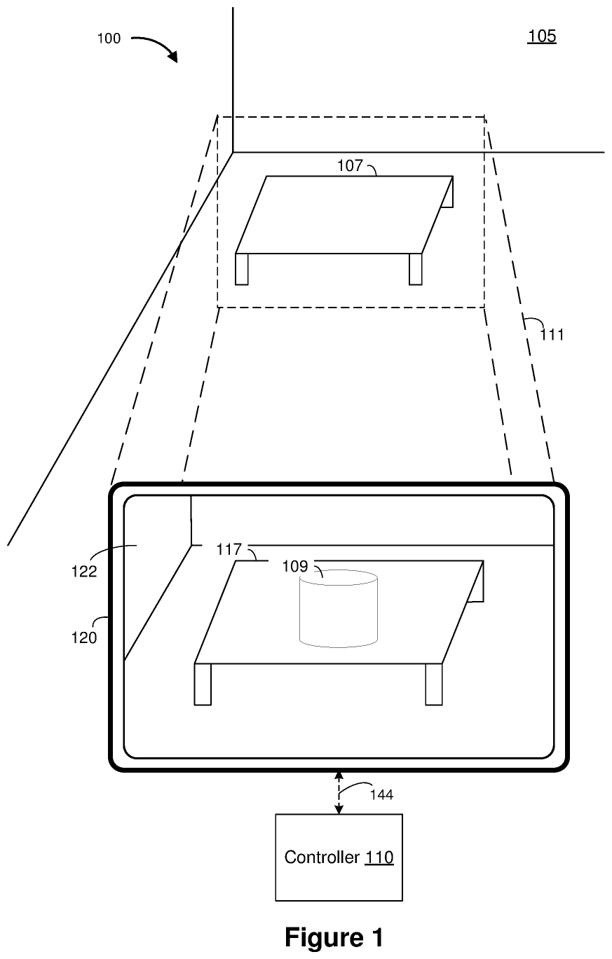

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

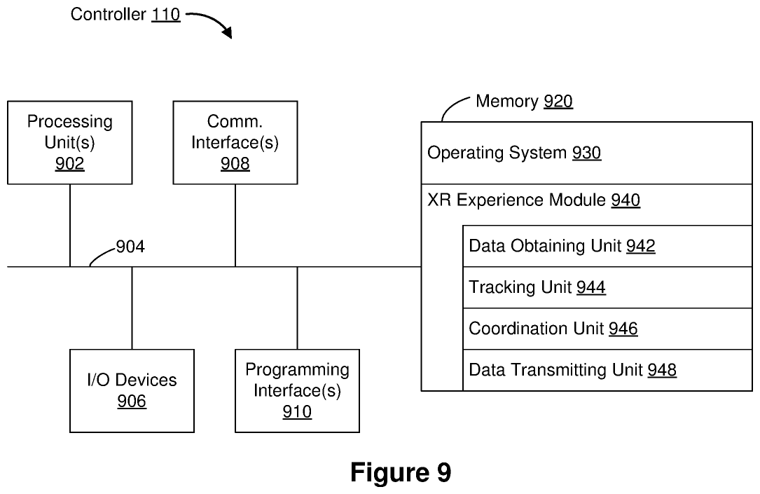

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 9. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

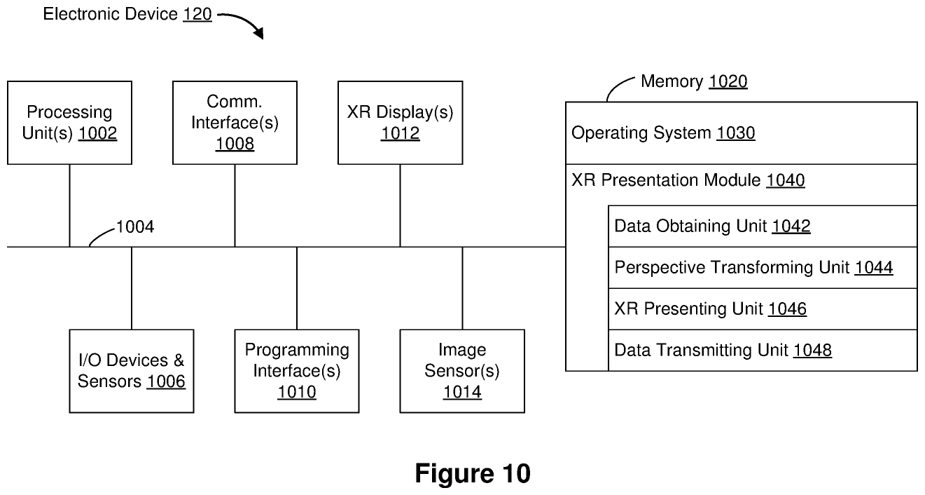

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 10.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

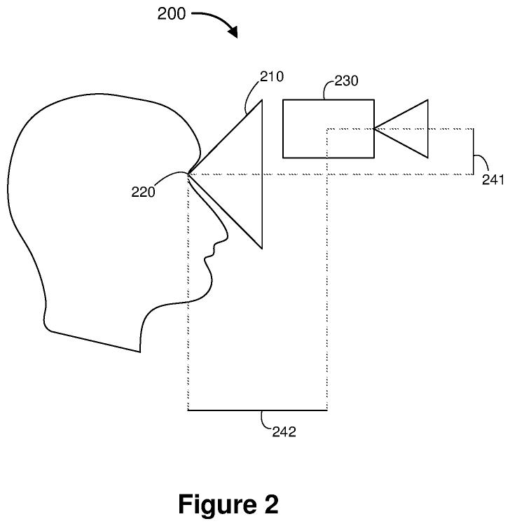

FIG. 2 illustrates an example scenario 200 related to capturing an image of an environment and displaying the captured image in accordance with some implementations. A user wears a device (e.g., the electronic device 120 of FIG. 1) including a display 210 and an image sensor 230. The image sensor 230 captures an image of a physical environment and the display 210 displays the image of the physical environment to the eyes 220 of the user. The image sensor 230 has a perspective that is offset vertically from the perspective of the user (e.g., where the eyes 220 of the user are located) by a vertical offset 241. Further, the perspective of the image sensor 230 is offset longitudinally from the perspective of the user by a longitudinal offset 242. Further, the perspective of the image sensor 230 is offset laterally from the perspective of the user by a lateral offset (e.g., into or out of the page in FIG. 2).

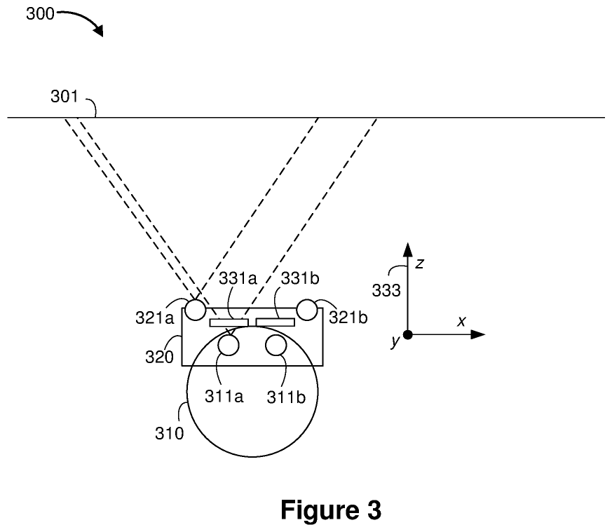

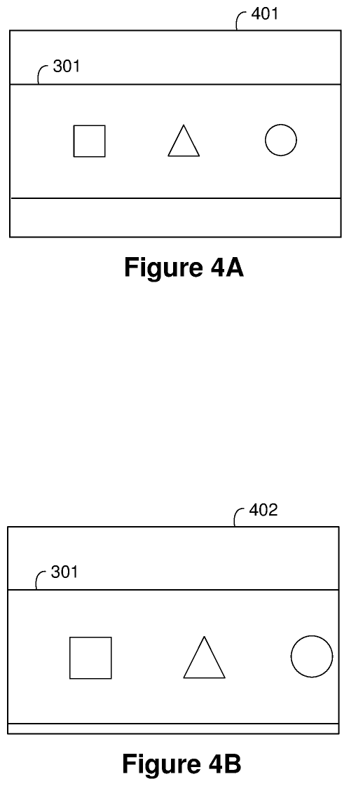

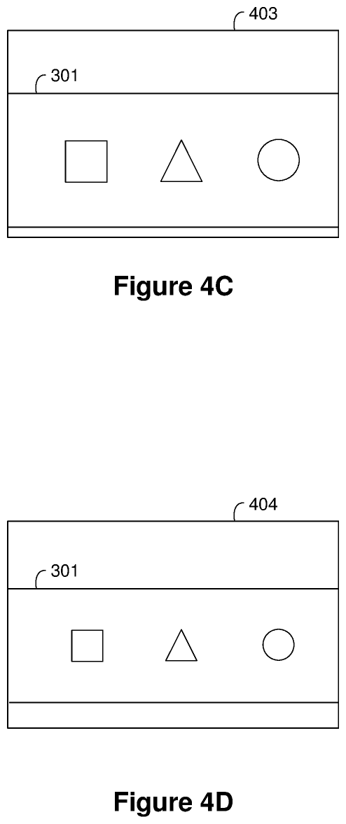

FIG. 3 is an overhead perspective view of a physical environment 300. The physical environment 300 includes a structure 301 and a user 310 wearing an HMD 320. The structure 301, as illustrated in the views and images described below with respect to FIGS. 4A-4D, has, painted thereon, a square, a triangle, and a circle. The user 310 has a left eye 311a at a left eye location in the device coordinate system providing a left eye perspective, e.g. at the center of the pupil of the eye. The user 310 has a right eye 311b at a right eye location providing a right eye perspective. The HMD 320 includes a left image sensor 321a at a left image sensor location providing a left image sensor perspective, e.g., at a center of the entrance pupil of the image sensor. The HMD 320 includes a right image sensor 321b at a right image sensor location providing a right image sensor perspective. Because the left eye 311a and the left image sensor 321a are at different locations, they each provide different perspectives of the physical environment. The HMD 320 further includes a left eye display 331a within a field-of-view of the left eye 311a and a right eye display 331b within a field-of-view of the right eye 311b.

FIG. 3 further illustrates axes 333 of a three-dimensional device coordinate system. In various implementations, the x-axis and y-axis are aligned with the horizontal u-axis and vertical v-axis of the left image sensor 321a (and/or the right image sensor 321b) and the z-axis is aligned with the optical axis of the left image sensor 321a (and/or the right image sensor 321b). In various implementations, the three-dimensional device coordinate system is not aligned with the left image sensor 321a and/or the right image sensor 321b.

FIG. 4A illustrates a view 401 of the physical environment 300 as would be seen by the left eye 311a of the user 310 if the user 310 were not wearing the HMD 320. In the view 401, the square, the triangle, and the circle can be seen on the structure 301.

FIG. 4B illustrates an image 402 of the physical environment 300 captured by the left image sensor 321a. In the image 402, like the view 401, the square, the triangle, and the circle can be seen on the structure 301. However, because the left image sensor 321a is to the left of the left eye 311a, the triangle and the circle on the structure 301 in the image 402 are at locations to the right of the corresponding locations of the triangle and the circle in view 401. Further, because the left image sensor 321a is higher than the left eye 311a, the square, the triangle, and the circle in the image 402 are at locations lower than the corresponding locations of the square, the triangle, and the circle in the view 401. Further, because the left image sensor 321a is closer to the structure 301 than the left eye 311a, the square, the triangle, and the circle are larger in the image 402 than in the view 401.

In various implementations, the HMD 320 transforms the image 402 to make it appear as though it was captured from the left eye perspective rather than the left image sensor perspective, e.g., to appear as the view 401. In various implementations, the transformation includes rectification of the image 402 with respect to the three-dimensional device coordinate system. In various implementations, the transformation is a projective transformation. In various implementations, the HMD 320 transforms the image 402 based on depth values associated with image 402 and a difference between the left image sensor perspective and the left eye perspective. In various implementations, the depth value for a pixel of the image 402 represents the distance from the left image sensor 321a to an object in the physical environment 300 represented by the pixel. In various implementations, the difference between the left image sensor perspective and the left eye perspective is determined during a calibration procedure.

In various implementations, the HMD 320 transforms the image 402 to make it appear as though it were captured at a second perspective not at the left eye perspective, but closer to the left eye perspective in at least one dimension of a three-dimensional device coordinate system of the HMD 320 rather than the left image sensor perspective.

In various implementations, transforming the image in any direction increases artifacts. In various implementations, transforming the image in specific directions can improve user comfort, a user's sense of depth, and a user's sense of scale.

Accordingly, in various implementations, the HMD 320 transforms the image 402 only in the x-direction to make it appear as though it were captured at a second perspective at a location with the same x-coordinate as the left eye location and the same y-coordinate and z-coordinate as the left image sensor location. In various implementations, the HMD 320 transforms the image 402 based on depth values associated with image 402 and a difference between the left image sensor perspective and the second perspective. In various implementations, the difference between the left image sensor perspective and the second perspective is determined during a calibration procedure.

FIG. 4C illustrates a first transformed image 403 of the physical environment 300 generated by transforming the image 402 only in the x-direction. Whereas, in the image 402, the triangle and the circle are to the right of the corresponding locations of the triangle and the circle in the view 401, in the first transformed image 403, the triangle and circle are at the same horizontal locations as the corresponding horizontal locations of the triangle and the circle in the view 401. However, in the first transformed image 403 (like the image 402), the square, the triangle, and the circle are at vertical locations lower than the corresponding vertical locations of the square, the triangle, and the circle in the view 401. Further, in the first transformed image 403 (like the image 402), the square, the triangle, and the circle are larger than the square, the triangle, and the circle in the view 401.

In various implementations, the HMD 320 transforms the image 402 only in the x-direction and the z-direction to make it appear as through it were captured at a second perspective at a location with the same x-coordinate and z-coordinate of the left eye location and the same y-coordinate as the left image sensor location.

FIG. 4D illustrates a second transformed image 404 of the physical environment 300 generated by transforming the image 402 only in the x-direction and z-direction. In the second transformed image, the triangle and the circle are at the same horizontal locations as the corresponding horizontal locations of the triangle and the circle in the view 401. Further, in the second transformed image, the square, the triangle, and the circle are the same size as the square, the triangle, and the circle in the view 401. However, in the second transformed image 403, the square, the triangle, and the circle are at vertical locations lower than the corresponding vertical locations of the square, the triangle, and the circle in the view 401.

In various implementations, the HMD 320 transforms the image 402 at least partially in each dimension to make it appear, for example, as though it were captured at a second perspective at a location with the same x-coordinate of the left eye location, a y-coordinate a third of the way from the y-coordinate of the left image sensor location to the left eye location, and a z-coordinate halfway between the z-coordinates of the left image sensor location and the left eye location.

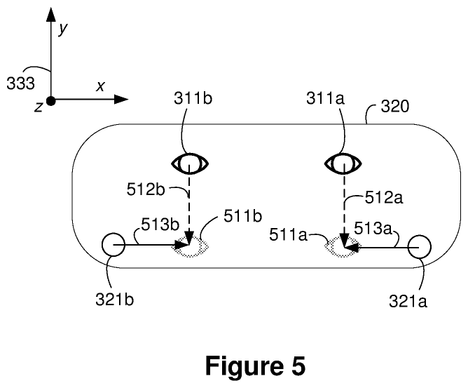

FIG. 5 illustrates a front view of the HMD 320 with a first perspective transform. In FIG. 5, an image captured by the left image sensor 321a is transformed from a first perspective of the left image sensor 321a to a second perspective at a location 511a having the same x-coordinate as the left eye 311a and the same y-coordinate as the left image sensor 321a. Similarly, an image captured by the right image sensor 321b is transformed from a first perspective of the right image sensor 321b to a second perspective at a location 511b having the same x-coordinate at the right eye 311b and the same y-coordinate as the right image sensor 321b.

Thus, the location of the left eye 311a and the location 511a of the second perspective form a vector 512a which is vertical and has a first length. The location of the left image sensor 321a and the location 511a of the second perspective form a vector 513a which is horizontal and has a second length. The location of the right eye 311b and the location 511b of the second perspective form a vector 512b which is vertical and has the first length. The vector 512a and the vector 512b have the same magnitude and the same direction. The location of the right image sensor 321b and the location 511b of the second perspective form a vector 513b which is horizontal and has the second length. The vector 513a and the vector 513b have the same magnitude but an opposite direction.

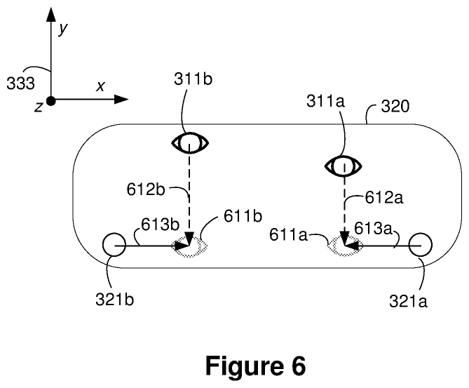

FIG. 6 illustrates a front view of the HMD 320 with a second perspective transform. In FIG. 6, the HMD 320 is tilted such that a line through the left eye 311a and the right eye 311b is no longer parallel to a line through the left image sensor 321a and the right image sensor 321b. In FIG. 6, an image captured by the left image sensor 321a is transformed from a first perspective of the left image sensor 321a to a second perspective at a location 611a having the same x-coordinate as the left eye 311a and the same y-coordinate as the left image sensor 321a. Similarly, an image captured by the right image sensor 321b is transformed from a first perspective of the right image sensor 321b to a second perspective at a location 611b having the same x-coordinate at the right eye 311b and the same y-coordinate as the right image sensor 321b.

Thus, the location of the left eye 311a and the location 611a of the second perspective form a vector 612a which is vertical and has a first length. The location of the left image sensor 321a and the location 611a of the second perspective form a vector 613a which is horizontal and has a second length. The location of the right eye 311b and the location 611b of the second perspective form a vector 612b which is vertical and has a third length, different than the first length. The vector 612a and the vector 612b have the same direction but a different magnitude. This difference in magnitude results in in a vertical disparity in which different eyes are subject to different magnitudes of vertical transformation. This can lead to an increase in discomfort and a decrease in aesthetics, such a binocular fusion difficulties. The location of the right image sensor 321b and the location 611b of the second perspective form a vector 613b which is horizontal and has a fourth length, which may be same or different than the second length. The vector 613a and the vector 613b have opposite directions and may have the same magnitude or different magnitudes.

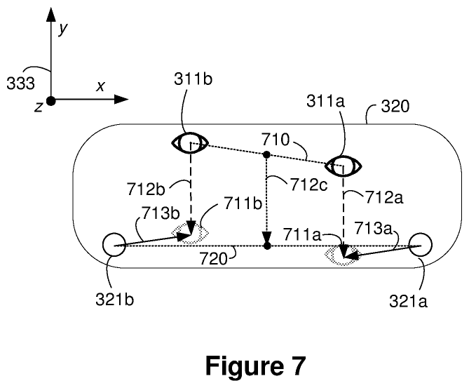

FIG. 7 illustrates a front view of the HMD 320 with a third perspective transform. In FIG. 7, as in FIG. 6, the HMD 320 is tilted such that a line 710 through the left eye 311a and the right eye 311b is not parallel to a line 720 through the left image sensor 321a and the right image sensor 321b. In FIG. 7, an image captured by the left image sensor 321a is transformed from a first perspective of the left image sensor 321a to a second perspective at a location 711a. Similarly, an image captured by the right image sensor 321b is transformed from a first perspective of the right image sensor 321b to a second perspective at a location 711b.

In various implementations, the line 710 and line 720 may be skewed for reasons other than tilt of the HMD 320, such as facial asymmetry, measurement/calibration errors, or extrinsic tolerances.

The HMD 320 determines the location 711a and the location 711b such that the vector 712a between the location of the left eye 311a and the location 711a of the second perspective has the same direction and the same magnitude as the vector 712b between the location of the right eye 311b and the location 711b of the second perspective. Thus, the vector 712a and the vector 712b are parallel.

In various implementations, the vector 712a and the vector 712b have the same magnitude and the same direction as a vector 712c between the midpoint of the line 710 connecting the left eye 311a and the right eye 31b and the midpoint of the line 720 connecting the left image sensor 321a and the right image sensor 321b. Thus, the vector 712a, the vector 712b, and the vector 712c are parallel. Because the vector 712a, the vector 712b, and the vector 712c are parallel, the vector 713a between the left image sensor 321a and the location 711a of the second perspective and the vector 713b between the right image sensor 321b and the location 711b of the second perspective have the same magnitude but an opposite direction. Accordingly, the vector 713a and the vector 713b are parallel. Further, because the line 710 and the line 720 are not parallel, the vector 713a and the vector 713b are not horizontal. In various implementations, the vector 712a and the vector 712b are not vertical.

In particular, the x-component of the vector 713a (and the vector 713b) is half the difference between (1) the horizontal displacement of the left eye 311a and the right eye 311b (e.g., the x-component of the line 710) and (2) the horizontal displacement of the left image sensor 321a and the right image sensor 321b (e.g., the x-component of the line 720). Similarly, the y-component of the vector 713a (and the vector 713b) is half the difference between (1) the vertical displacement of the left eye 311a and the right eye 311b (e.g., the y-component of the line 710) and (2) the vertical displacement of the left image sensor 321a and the right image sensor 321b (e.g., the y-component of the line 720).

In various implementations, the z-component of the vector 713a and the vector 713b is determined as described above for the x-component and the y-component (e.g., using the vector 712c as determined using the midpoints of the line 710 and the line 720 in three dimensions. In various implementations, the z-component of the vector 713a and the vector 713b is set to zero.

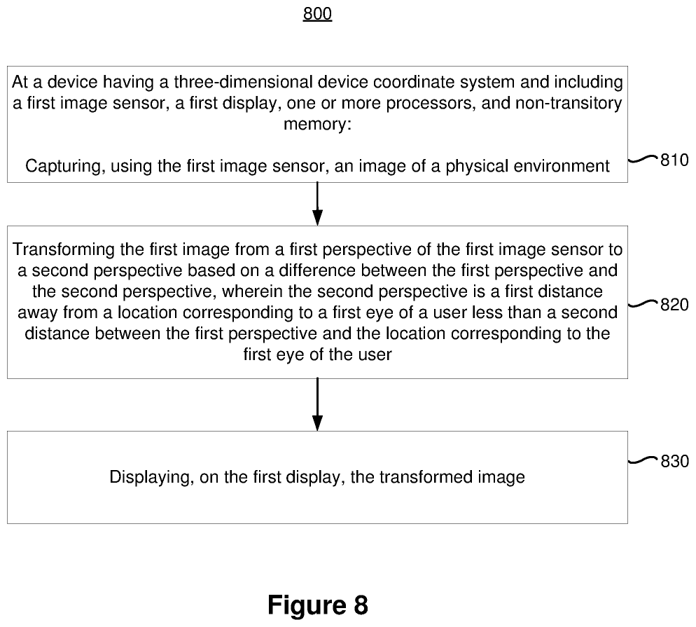

FIG. 8 is a flowchart representation of a method of performing partial perspective correction of an image in accordance with some implementations. In various implementations, the method 800 is performed by a device having a three-dimensional coordinate system and including a first image sensor, a display, one or more processors, and non-transitory memory (e.g., the electronic device 120 of FIG. 1). In some implementations, the method 800 is performed by processing logic, including hardware, firmware, software, or a combination thereof. In some implementations, the method 800 is performed by a processor executing instructions (e.g., code) stored in a non-transitory computer-readable medium (e.g., a memory).

The method 800 begins, in block 810, with the device capturing, using the first image sensor, a first image of a physical environment.

The method 800 continues, in block 820, with the device transforming, using the one or more processors, the first image of the physical environment based on a difference between a first perspective of the image sensor and a second perspective, wherein the second perspective is a first distance away from a location corresponding to a first eye of a user less than a second distance between the first perspective and location corresponding to the first eye of the user. In various implementations, the device transforms the first image of the physical environment at an image pixel level, an image tile level, or a combination thereof.

In various implementations, the device transforms the first image of the physical environment based on a depth map including a plurality of depths respectively associated with a plurality of pixels of the first image of the physical environment. In various implementations, the depth map includes a dense depth map which represents, for each pixel of the first image, an estimated distance between the first image sensor and an object represented by the pixel. In various implementations, the depth map includes a sparse depth map which represents, for each of a subset of the pixels of the first image, an estimated distance between the first image sensor and an object represented by the pixel. In various implementations, the device generates a sparse depth map from a dense depth map by sampling the dense depth map, e.g., selecting a single pixel in every N×N block of pixels.

In various implementations, the device obtains the plurality of depths from a depth sensor. In various implementations, the device obtains the plurality of depths using stereo matching, e.g., using the image of the physical environment as captured by a left scene camera and another image of the physical environment captured by a right scene camera. In various implementations, the device obtains the plurality of depths through eye tracking, e.g., the intersection of the gaze directions of the two eyes of the user indicates the depth of an object at which the user is looking.

In various implementations, the device obtains the plurality of depths from a three-dimensional model of the physical environment, e.g., via rasterization of the three-dimensional model and/or ray tracing from the image sensor to various features of the three-dimensional model.

In various implementations, the second perspective and the location corresponding to the first eye of the user have the same coordinate value for at least one dimension of the device coordinate system. For example, in FIG. 4C, the image 402 is transformed only in the x-dimension and the second perspective and the left eye 311a share an x-coordinate. In various implementations, the second perspective and the location corresponding to the first eye of the user have the same coordinate value for two dimensions of the device coordinate system. For example, in FIG. 4D, the image 402 is transformed in the x-dimension and z-dimension and the second perspective and the left eye 311a share an x-coordinate and a z-coordinate.

In various implementations, the second perspective and the location corresponding to the first eye of the user have the same coordinate value for less than three dimensions of the device coordinate system. For example, in FIG. 4D, the image 402 is transformed in the x-dimension and the z-dimension and the second perspective and the left eye 311a have different y-coordinates. In various implementations, the second perspective and the location corresponding to the first eye of the user have the same coordinate value for less than two dimensions of the device coordinate system. For example, in FIG. 4C, the image 402 is transformed only in the x-dimension and the second perspective and the left eye 311a have different y-coordinates and different z-coordinates. In various implementations, the second perspective and the location corresponding to the first eye of the user have the same coordinate value for less than one dimension of the device coordinate system. Thus, in various implementations, the second perspective and the location corresponding to the first eye of the user have different coordinate values for all three dimensions. For example, in FIG. 7, the location 711a of the second perspective and the left eye 311a have different x-coordinates, different y-coordinates, and different z-coordinates.

In various implementations, a first ratio between (1) a displacement in a first dimension of the device coordinate system between the first perspective and the second perspective and (2) a displacement in the first dimension between the first perspective and the location corresponding to the first eye of the user is different than a second ratio between (1) a displacement in a second dimension of the device coordinate system between the first perspective and the second perspective and (2) a displacement in the second dimension between the first perspective and the location corresponding to the first eye of the user. In various implementations, the first ratio is approximately zero. In various implementations, the first ratio is approximately one. In various implementations, the first ratio is between zero and one. For example, in various implementations, the first ratio is between approximately 0.25 and 0.75. For example, in FIG. 5, the ratio between (1) the y-dimension displacement between the left image sensor 321a and the location 511a of the second perspective and (2) the y-dimension displacement between the image sensor 321a and the left eye 311a is approximately zero. As another example, in FIG. 5, the ratio between (1) the x-dimension displacement between the image sensor 321a and the location 511a of the second perspective and (2) the x-dimension displacement between the left image sensor 321a and the left eye 311a is approximately one. Accordingly, in various implementations, the first dimension is an x-dimension, the second dimension is a y-dimension, and the first ratio is greater than the second ratio. As another example, in FIG. 7, the ratio between (1) the y-dimension displacement between the right image sensor 321b and the location 511b of the second perspective and (2) the y-dimension displacement between the right image sensor 321b and the right eye 311b is between zero and one (e.g., approximately 0.1).

In various implementations, the device performs a projective transformation based on the depth map and the difference between the first perspective of the first image sensor and the second perspective.

In various implementations, the projective transformation is a forward mapping in which, for each pixel of the first image of the physical environment at a pixel location in an untransformed space, a new pixel location is determined in a transformed space of the transformed first image. In various implementations, the projective transformation is a backwards mapping in which, for each pixel of the transformed first image at a pixel location in a transformed space, a source pixel location is determined in an untransformed space of the first image of the physical environment.

In various implementations, the source pixel location is determined according to the following equation in which x₁ and y₁ are the pixel location in the untransformed space, x₂ and y₂ are the pixel location in the transformed space, P₂ is a 4×4 view projection matrix of the second perspective, P₁ is a 4×4 view projection matrix of the first perspective of the image sensor, and d is the depth map value at the pixel location:

$$[ \begin{matrix}\begin{matrix}{x}_{1} \\ {y}_{1}\end{matrix} \\ 1\end{matrix} ] ← {P}_{1} \cdot {P}_{2}^{- 1} \cdot [ \begin{matrix}\begin{matrix}\begin{matrix}{x}_{2} \\ {y}_{2}\end{matrix} \\ 1\end{matrix} \\ ( \frac{1}{d} )\end{matrix} ]$$

In various implementations, the source pixel location is determined using the above equation for each pixel in the first image of the physical environment. In various implementations, the source pixel location is determined using the above equation for less than each pixel of the first image of the physical environment.

In various implementations, the device determines the view projection matrix of the second perspective and the view projection matrix of the first perspective during a calibration and stores data indicative of the view projection matrices (or their product) in a non-transitory memory. The product of the view projection matrices is a transformation matrix that represents a difference between the first perspective of the first image sensor and the second perspective.

Thus, in various implementations, transforming the first image of the physical environment includes determining, for a plurality of pixels of the transformed first image having respective pixel locations, a respective plurality of source pixel locations. In various implementations, determining the respective plurality of source pixel locations includes, for each of the plurality of pixels of the transformed first image, multiplying a vector including the respective pixel location and the multiplicative inverse of the respective element of the depth map by a transformation matrix representing the difference between the first perspective of the image sensor and the second perspective.

Using the source pixel locations in the untransformed space and the pixel values of the pixels of the first image of the physical environment, the device generates pixel values for each pixel location of the transformed first image using interpolation or other techniques.

In various implementations, the method 800 includes determining the second perspective. In various implementations, the method 800 includes determining the second perspective based on the location corresponding to the first eye of the user. Thus, in various implementations, the method 800 includes determining the location corresponding to the first eye of the user. In various implementations, the device measures the location corresponding to the first eye of the user based on a current image (obtained at the same time as capturing the image of the physical environment) including the first eye of the user. In various implementations, the device predicts the location corresponding to the first eye of the user based on previous images (obtained prior to capturing the image of the environment) including the first eye of the user. In various implementations, the device estimates the location corresponding the first eye of the user based on an IMU (inertial measurement unit) of the device. For example, if the IMU indicates that the device is level, the device estimates the location corresponding to the first eye of the user as being a fixed distance perpendicularly away from the center of the display. However, if the IMU indicates that the device is tilted, the device estimates the location corresponding the first eye of the user as being laterally offset from the fixed distance perpendicularly away from the center of the display.

The method 800 continues, in block 830, with the device displaying, on the first display, the transformed first image of the physical environment. In various implementations, the transformed first image includes XR content. In some implementations, XR content is added to the first image of the physical environment before the transformation (at block 820). In some implementations, XR content is added to the transformed first image.

In various implementations, the method 800 includes performing splay mitigation. For example, in various implementations, the method 800 includes capturing, using a second image sensor, a second image of a physical environment. The method 800 includes transforming the second image from a third perspective of the second image sensor to a fourth perspective based on a difference between the third perspective and the fourth perspective. The method includes displaying, on a second display, the transformed second image of the physical environment.

In various implementations, a vector between the second perspective and the location corresponding to the first eye of the user is parallel to a vector between the fourth perspective and a location corresponding to a second eye of the user. For example, in FIG. 7, the vector 712b is parallel to the vector 712a. In various implementations, the vector between the second perspective and the location corresponding to the first eye of the user is parallel to a midpoint vector between (1) the midpoint between the location corresponding to the first eye of the user and the location corresponding to the second eye of the user and (2) the midpoint between the first image sensor and the second image sensor. For example, in FIG. 7, the vector 712b is parallel to the vector 712c. In various implementations, the vector between the second perspective and the location corresponding to the first eye of the user is a same magnitude as the midpoint vector. In various implementations, a vector between the first perspective and the second perspective is parallel to a vector between the third perspective and the fourth perspective. For example, in FIG. 7, the vector 713b is parallel to the vector 713a.

In various implementations, the fourth perspective is a third distance away from a location corresponding to a second eye of a user less than a fourth distance between the second image sensor and the location corresponding to the second eye of the user. In various implementations, the fourth perspective is a third distance away from a location corresponding to a second eye of a user greater than a fourth distance between the second image sensor and the location corresponding to the second eye of the user. Thus, whereas the distance between the location 711b of the second perspective and the right eye 311a is less than the distance between the right image sensor 321a and the right eye 311b. In various implementations, the distance between the location 711a of the second perspective and the left eye 311a can be less or more than the distance between the left image sensor 321a and the left eye 311a depending on the amount of vertical displacement between the left eye 311a and the right eye 311b.

FIG. 9 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 902 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 906, one or more communication interfaces 908 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 910, a memory 920, and one or more communication buses 904 for interconnecting these and various other components.

In some implementations, the one or more communication buses 904 include circuitry that interconnects and controls communications between system components. In some implementations, the one or more I/O devices 906 include at least one of a keyboard, a mouse, a touchpad, a joystick, one or more microphones, one or more speakers, one or more image sensors, one or more displays, and/or the like.

The memory 920 includes high-speed random-access memory, such as dynamic random-access memory (DRAM), static random-access memory (SRAM), double-data-rate random-access memory (DDR RAM), or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 comprises a non-transitory computer readable storage medium. In some implementations, the memory 920 or the non-transitory computer readable storage medium of the memory 920 stores the following programs, modules and data structures, or a subset thereof including an optional operating system 930 and an XR experience module 940.

The operating system 930 includes procedures for handling various basic system services and for performing hardware dependent tasks. In some implementations, the XR experience module 940 is configured to manage and coordinate one or more XR experiences for one or more users (e.g., a single XR experience for one or more users, or multiple XR experiences for respective groups of one or more users). To that end, in various implementations, the XR experience module 940 includes a data obtaining unit 942, a tracking unit 944, a coordination unit 946, and a data transmitting unit 948.

In some implementations, the data obtaining unit 942 is configured to obtain data (e.g., presentation data, interaction data, sensor data, location data, etc.) from at least the electronic device 120 of FIG. 1. To that end, in various implementations, the data obtaining unit 942 includes instructions and/or logic therefor, and heuristics and metadata therefor.

In some implementations, the tracking unit 944 is configured to map the physical environment 105 and to track the position/location of at least the electronic device 120 with respect to the physical environment 105 of FIG. 1. To that end, in various implementations, the tracking unit 944 includes instructions and/or logic therefor, and heuristics and metadata therefor.

In some implementations, the coordination unit 946 is configured to manage and coordinate the XR experience presented to the user by the electronic device 120. To that end, in various implementations, the coordination unit 946 includes instructions and/or logic therefor, and heuristics and metadata therefor.

In some implementations, the data transmitting unit 948 is configured to transmit data (e.g., presentation data, location data, etc.) to at least the electronic device 120. To that end, in various implementations, the data transmitting unit 948 includes instructions and/or logic therefor, and heuristics and metadata therefor.

Although the data obtaining unit 942, the tracking unit 944, the coordination unit 946, and the data transmitting unit 948 are shown as residing on a single device (e.g., the controller 110), it should be understood that in other implementations, any combination of the data obtaining unit 942, the tracking unit 944, the coordination unit 946, and the data transmitting unit 948 may be located in separate computing devices.

Moreover, FIG. 9 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 9 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 10 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 1010, one or more XR displays 1012, one or more optional interior- and/or exterior-facing image sensors 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 1012 are configured to provide the XR experience to the user. In some implementations, the one or more XR displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 1012 correspond to diffractive, reflective, polarized, holographic, etc. waveguide displays. For example, the electronic device 120 includes a single XR display. In another example, the electronic device includes an XR display for each eye of the user. In some implementations, the one or more XR displays 1012 are capable of presenting MR and VR content.

In some implementations, the one or more image sensors 1014 are configured to obtain image data that corresponds to at least a portion of the face of the user that includes the eyes of the user (any may be referred to as an eye-tracking camera). In some implementations, the one or more image sensors 1014 are configured to be forward-facing so as to obtain image data that corresponds to the physical environment as would be viewed by the user if the electronic device 120 was not present (and may be referred to as a scene camera). The one or more optional image sensors 1014 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium. In some implementations, the memory 1020 or the non-transitory computer readable storage medium of the memory 1020 stores the following programs, modules and data structures, or a subset thereof including an optional operating system 1030 and an XR presentation module 1040.

The operating system 1030 includes procedures for handling various basic system services and for performing hardware dependent tasks. In some implementations, the XR presentation module 1040 is configured to present XR content to the user via the one or more XR displays 1012. To that end, in various implementations, the XR presentation module 1040 includes a data obtaining unit 1042, a perspective transforming unit 1044, an XR presenting unit 1046, and a data transmitting unit 1048.

In some implementations, the data obtaining unit 1042 is configured to obtain data (e.g., presentation data, interaction data, sensor data, location data, etc.) from at least the controller 110 of FIG. 1. To that end, in various implementations, the data obtaining unit 1042 includes instructions and/or logic therefor, and heuristics and metadata therefor.

In some implementations, the perspective transforming unit 1044 is configured to perform partial perspective correction. To that end, in various implementations, the perspective transforming unit 1044 includes instructions and/or logic therefor, and heuristics and metadata therefor.

In some implementations, the XR presenting unit 1046 is configured to display the transformed image via the one or more XR displays 1012. To that end, in various implementations, the XR presenting unit 1046 includes instructions and/or logic therefor, and heuristics and metadata therefor.

In some implementations, the data transmitting unit 1048 is configured to transmit data (e.g., presentation data, location data, etc.) to at least the controller 110. In some implementations, the data transmitting unit 1048 is configured to transmit authentication credentials to the electronic device. To that end, in various implementations, the data transmitting unit 1048 includes instructions and/or logic therefor, and heuristics and metadata therefor.

Although the data obtaining unit 1042, the perspective transforming unit 1044, the XR presenting unit 1046, and the data transmitting unit 1048 are shown as residing on a single device (e.g., the electronic device 120), it should be understood that in other implementations, any combination of the data obtaining unit 1042, the perspective transforming unit 1044, the XR presenting unit 1046, and the data transmitting unit 1048 may be located in separate computing devices.

Moreover, FIG. 10 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 10 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a three-dimensional device coordinate system and including a first image sensor, a first display, one or more processors, and non-transitory memory:
capturing, using the first image sensor, a first image of a physical environment;
transforming the first image from a first perspective of the first image sensor to a second perspective based on a difference between the first perspective and the second perspective, wherein the second perspective is a first distance away from a location corresponding to a first eye of a user less than a second distance between the first perspective and the location corresponding to the first eye of the user; and
displaying, on the first display, the transformed first image of the physical environment.

2. The method of claim 1, wherein the second perspective and the location corresponding to the first eye of the user have the same coordinate value for at least one dimension of the device coordinate system.

3. The method of claim 2, wherein the second perspective and the location corresponding to the first eye of the user have the same coordinate value for two dimensions of the device coordinate system.

4. The method of claim 1, wherein the second perspective and the location corresponding to the first eye of the user have the same coordinate value for less than three dimensions of the device coordinate system.

5. The method of claim 4, wherein the second perspective and the location corresponding to the first eye of the user have the same coordinate value for less than two dimensions of the device coordinate system.

6. The method of claim 5, wherein the second perspective and the location corresponding to the first eye of the user have different coordinate values for each dimension of the device coordinate system.

7. The method of claim 1, wherein a first ratio between (1) a displacement in a first dimension of the device coordinate system between the first perspective and the second perspective and (2) a displacement in the first dimension between the first perspective and the location corresponding to the first eye of the user is different than a second ratio between (1) a displacement in a second dimension of the device coordinate system between the first perspective and the second perspective and (2) a displacement in the second dimension between the first perspective and the location corresponding to the first eye of the user.

8. The method of claim 7, wherein the first ratio is approximately zero.

9. The method of claim 7, wherein the first ratio is approximately one.

10. The method of claim 7, wherein the first ratio is between zero and one.

11. The method of claim 1, further comprising:
capturing, using a second image sensor, a second image of a physical environment;
transforming the second image from a third perspective of the second image sensor to a fourth perspective based on a difference between the third perspective and the fourth perspective; and
displaying, on a second display, the transformed second image of the physical environment.

12. The method of claim 11, wherein a vector between the second perspective and the location corresponding to the first eye of the user is parallel to a vector between the fourth perspective and a location corresponding to a second eye of the user.

13. The method of claim 11, wherein the vector between the second perspective and the location corresponding to the first eye of the user is parallel to a midpoint vector between (1) the midpoint between the location corresponding to the first eye of the user and a location corresponding to a second eye of the user and (2) the midpoint between the first image sensor and the second image sensor.

14. The method of claim 13, wherein the vector between the second perspective and the location corresponding to the first eye of the user has a same magnitude as the midpoint vector.

15. The method of claim 11, wherein a vector between the first perspective and the second perspective is parallel to a vector between the third perspective and the fourth perspective.

16. A device comprising:
a first image sensor;
a first display;
a non-transitory memory; and
one or more processors to:
capture, using the first image sensor, a first image of a physical environment;
transform the first image from a first perspective of the first image sensor to a second perspective based on a difference between the first perspective and the second perspective, wherein a first ratio between (1) a displacement in a first dimension of the device coordinate system between the first perspective and the second perspective and (2) a displacement in the first dimension between the first perspective and a location corresponding to a first eye of the user is different than a second ratio between (1) a displacement in a second dimension of the device coordinate system between the first perspective and the second perspective and (2) a displacement in the second dimension between the first perspective and the location corresponding to the first eye of the user; and
displaying, on the first display, the transformed first image of the physical environment.

17. The device of claim 16, wherein the one or more processors are further to:
capture, using a second image sensor, a second image of a physical environment;
transform the second image from a third perspective of the second image sensor to a fourth perspective based on a difference between the third perspective and the fourth perspective; and
display, on a second display, the transformed second image of the physical environment.

18. The device of claim 17, wherein a vector between the second perspective and the location corresponding to the first eye of the user is parallel to a vector between the fourth perspective and a location corresponding to a second eye of the user.

19. The device of claim 17, wherein the vector between the second perspective and the location corresponding to the first eye of the user is parallel to a midpoint vector between (1) the midpoint between the location corresponding to the first eye of the user and a location corresponding to a second eye of the user and (2) the midpoint between the first image sensor and the second image sensor.

20. A non-transitory computer-readable memory having instructions encoded thereon which, when executed by one or more processors of a device including a first image sensor, a second image sensor, a first display, and a second display, cause the device to:
capture, using the first image sensor, a first image of a physical environment;
capture, using the second image sensor, a second image of the physical environment;
transform the first image from a first perspective of the first image sensor to a second perspective based on a difference between the first perspective and the second perspective;
transform the second image from a third perspective of the second image sensor to a fourth perspective based on a difference between the third perspective and the fourth perspective, wherein a vector between the second perspective and a location corresponding to a first eye of the user is parallel to a vector between the fourth perspective and a location corresponding to a second eye of the user;
display, on the first display, the transformed first image of the physical environment; and
display, on the second display, the transformed second image of the physical environment.
